(19) United States
(12) Patent Application Publication
(10) Pub. No.: US 2022/0066935 A1
(43) Pub. Date: Mar. 3, 2022

(54) MEMORY CACHE FOR DISAGGREGATED MEMORY

(71) Applicant: Microsoft Technology Licensing, LLC, Redmond, WA (US)

(72) Inventors: Siamak TAVALLAEI, Spring, TX (US); Ishwar AGARWAL, Redmond, WA (US); Vishal SONI, Redmond, WA (US)

(73) Assignee: Microsoft Technology Licensing, LLC, Redmond, WA (US)

(21) Appl. No.: 17/011,858

(22) Filed: Sep. 3, 2020

(51) Int. Cl. G06F 12/0806; G06F 12/0895

(52) U.S. Cl. CPC G06F 12/0806; G06F 2212/608; G06F 2212/1021; G06F 12/0895

(57) ABSTRACT

A memory control system comprises a memory cache and a disaggregated memory pool including a plurality of physical memory media configured to provide volatile data storage for any of a plurality of compute nodes communicatively coupled with the disaggregated memory pool. Processing componentry of the memory control system is configured to populate the memory cache with data items stored by the plurality of compute nodes within the disaggregated memory pool according to a cache fill policy. Upon receiving a memory read request for a data item stored in the disaggregated memory pool from a compute node, the memory cache and disaggregated memory pool are searched in parallel for the data item. Upon retrieving the data item from either the memory cache or disaggregated memory pool, the data item is provided to the compute node.

### BACKGROUND

Data centers typically include large numbers of discrete compute nodes, such as server computers or other suitable computing devices. Such devices may work independently and/or cooperatively to fulfill various computational workloads.

### BRIEF DESCRIPTION OF THE DRAWINGS

FIG. 1 schematically depicts a plurality of compute nodes communicatively coupled with a disaggregated memory pool.

FIG. 2 illustrates an example method for memory caching.

FIG. 3 schematically illustrates populating a memory cache according to a cache fill policy.

FIG. 4 schematically illustrates searching of a memory cache and plurality of physical memory units for a data item.

FIG. 5 schematically illustrates confirming that a compute node is authorized to access a requested data item.

FIG. 6 schematically illustrates receipt of quality of service policies from a fabric manager.

FIG. 7 schematically shows an example computing system.

### DETAILED DESCRIPTION

As discussed above, data centers typically include large numbers of discrete compute nodes, such as server computers or other suitable computing devices. Such compute nodes may be referred to as “host computing devices,” or “hosts,” as they may in some cases be used to host a plurality of virtual machines. Alternatively, a compute node may be implemented as a virtual machine, in which case multiple individual compute nodes may be hosted by the same computing device (e.g., server computer). It will be understood, however, that a compute node may be used for any suitable computing purpose, and may be applied toward any type of computational workload.

Depending on the specific implementation, each individual compute node may have any suitable collection of computer hardware. For instance, traditional servers may each be substantially self-sufficient, including processing resources, data storage, volatile/non-volatile memory, network interface componentry, a power supply, a cooling solution, etc. By contrast, some “blade servers” omit internal power supplies, cooling systems, and/or network interfaces, instead relying on a central rack to provide such infrastructure-type functionality for each of a cluster of individual blade servers plugged into the rack.

Regardless, each individual compute node will typically include some local collection of hardware resources, including data storage, memory, processing resources, etc. However, computational workloads (e.g., associated with data center customers) are often not uniformly distributed between each of the compute nodes in the data center. Rather, in a common scenario, a subset of compute nodes in the data center may be tasked with resource-intensive workloads, while other nodes sit idle or handle relatively less resource-intensive tasks. Thus, the total resource utilization of the data center may be relatively low, and yet completion of some workloads may be resource-constrained due to how such workloads are localized to individual nodes. This represents an inefficient use of the available computer resources, and is sometimes known as “resource stranding,” as computer resources that could potentially be applied to computing workloads are instead stranded in idle or underutilized hosts.

This problem can be mitigated when hardware resources are pulled out of individual compute nodes and are instead disaggregated as separate resource pools that can be flexibly accessed by connected compute nodes. For example, the present disclosure primarily contemplates scenarios in which volatile memory hardware (e.g., random-access memory (RAM)) is collected as part of a disaggregated memory pool, from which it may be utilized by any of a plurality of compute nodes—e.g., in a data center. This serves to alleviate resource stranding, as compute nodes are free to request memory when needed, and release such memory when no longer needed.

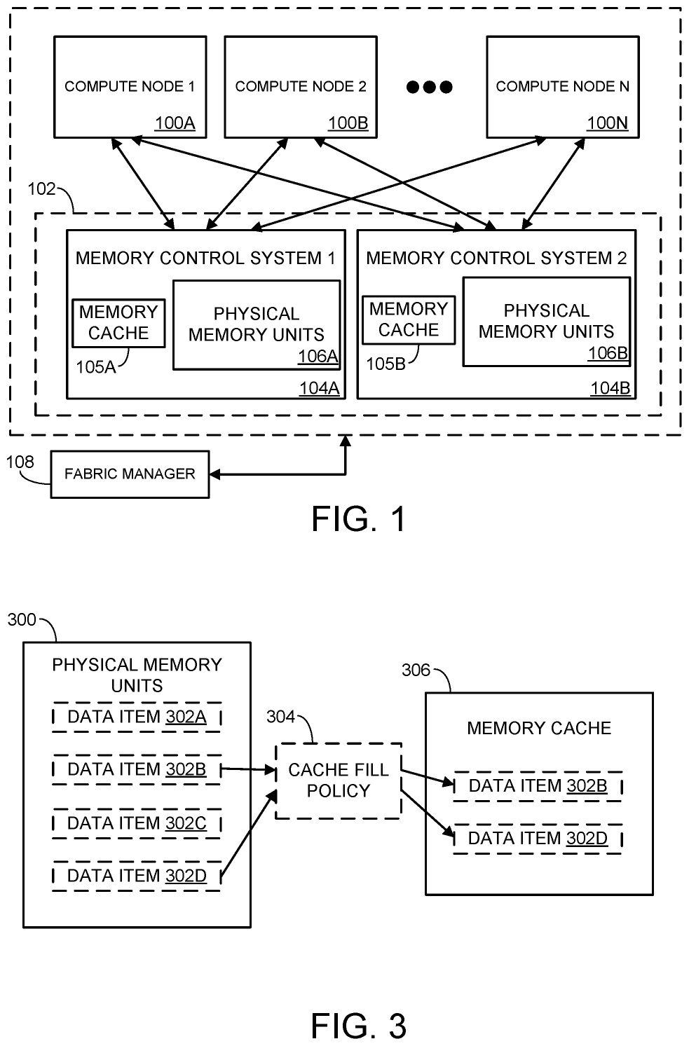

This is schematically illustrated with respect to FIG. 1. As shown, a plurality of compute nodes 100A-100N (where N is any suitable positive integer) are communicatively coupled with a disaggregated memory pool 102. In other words, the “disaggregated” memory pool includes a collection of volatile memory storage devices (e.g., RAM) that are discrete from, but accessible by, any of the plurality of compute nodes. For example, if any particular node in the plurality runs low on internal natively attached memory, the node may consume additional remote memory from the disaggregated pool. In various examples, dozens, hundreds, thousands, or more individual compute nodes may share access to one or more disaggregated resource pools, including disaggregated memory pool 102.

The disaggregated memory pool is comprised of at least two memory control systems 104A and 104B, which respectively govern and maintain sets of physical memory units 106A and 106B configured to provide volatile data storage for any of the plurality of compute nodes communicatively coupled with the disaggregated memory pool. In this example, the memory control systems cooperate to provide a single disaggregated memory pool. In other examples, however, a disaggregated memory pool may only include one memory control system. The memory control systems may, as one example, be compute express link (CXL)-compliant pooled memory controllers (CPMCs). The physical memory units may, for example, be any suitable type of volatile RAM—e.g., Double Data Rate Synchronous Dynamic RAM (DDR SDRAM). The memory control systems may facilitate use of the physical memory units by any or all of the various compute nodes 100A-100N. It will be understood that a disaggregated memory pool may include any suitable number of physical memory units, corresponding to any suitable total memory capacity, and may be governed by any number of different memory control systems.

Furthermore, it will be understood that the specific arrangements depicted in FIG. 1 are not limiting, and that FIG. 1 (as well as the other FIGS. described herein) are presented only as visual aids. Typical embodiments will be dramatically scaled up from the simplified examples herein, and will involve thousands or more compute nodes being serviced by large numbers of memory control systems. The memory control systems may in turn control any number of physical memory units, which may store any amount of computer data received from the compute nodes.

In some examples, the amount of memory collectively allocated to the plurality of compute nodes may exceed the amount of memory actually provisioned in the disaggregated memory pool. This is sometimes referred to as “thin provisioning.” In general, in data center environments without thin provisioning, it can be observed that individual compute nodes (and/or virtual machines implemented on the compute nodes) are often provisioned with more resources (e.g., storage space, memory) than the compute nodes end up actually using, statistically over time. For instance, the amount of memory installed for a particular compute node may be significantly higher than the amount of memory actually utilized by the compute node in most situations. When compounded over a plurality of compute nodes, the amount of unused memory (or other resources) can represent a significant fraction of the total memory in the data center.

In one example scenario without thin provisioning, a disaggregated memory pool may include 1 TB (1024 GB) of total memory, which may be distributed evenly between eight compute nodes. Furthermore, each compute node may include 128 GB of natively-attached memory. Thus, each compute node may be assigned 128 GB of memory of the disaggregated memory pool, while having a total of 256 GB of provisioned memory between the natively attached memory and pooled memory. In aggregate, the eight compute nodes may have access to 2 TB of memory total, again between the natively attached memory and pooled memory. In this example, as a result to the 128 GB of native memory and 128 GB of pooled memory, each node is allocated 256 GB of memory from the perspective of the node's internal OS and memory system. That is, the node “sees” 256 GB of available memory.

However, it is generally unlikely that each compute node will fully utilize its memory allocation. Rather, in a more common scenario, each compute node may only use a maximum of 50% of its allocated memory during normal usage, and some compute nodes may use significantly less than 50%. As such, even though the 1 TB disaggregated memory pool will be fully assigned to the plurality of compute nodes, only a relatively small fraction of the pooled memory may be in use at any given time, and this represents an inefficient use of the available resources.

Given this, the amount of memory actually available—i.e., “provisioned” in the memory pool could be reduced without significantly affecting performance of the plurality of compute nodes. For instance, the memory space of each compute node could still be constructed so that the pool portion of its memory allocation was 128 GB (thus amounting to 1 TB when summing the eight nodes), for example by providing an address range for 128 GB remote memory, however, the memory pool could be actually provisioned with only a total of 256 GB. Thus, the amount of allocated memory exceeds the amount of memory that is actually provisioned. In other words, while each particular compute node may be allocated 128 GB of pool memory, it is statistically likely that many compute nodes will not use all, or even a significant portion, of that 128 GB at any given time. Any unused memory assigned to one compute node may therefore be reassigned to one or more of the other nodes. In this manner, any particular compute node has the option to use up to 128 GB of pool memory if needed, while still conserving memory in the disaggregated pool, due to the fact that each compute node typically will not use 128 GB at any given time.

Such thin provisioning may be done to any suitable extent. It is generally beneficial for the amount of available memory to exceed the amount of memory typically used by the plurality of compute nodes under typical circumstances. In other words, if the compute nodes typically use around 256 GB, then it is generally desirable to have more than 256 GB of memory actually provisioned between the natively-attached memory and pooled memory, such that the compute nodes do not exhaust the available memory during normal use. In practice, however, any suitable amount of memory may be provisioned in the disaggregated memory pool, which may have any suitable relationship with the amount of memory allocated to the plurality of compute nodes.

When thin provisioning is implemented, there may be instances in which the plurality of compute nodes attempts to collectively use more memory than is available in the disaggregated memory pool. This may be referred to as “pressuring” the memory pool. Various actions may be taken to address this scenario. For example, memory assignment may be stripped away from one or more compute nodes regarded as having a lower priority or lower need for the memory. Additionally, or alternatively, memory requests for the plurality of compute nodes may be routed to a different disaggregated memory pool that may still have available memory, at the cost of higher latency.

Notably, the memory addressing techniques described herein may be implemented with or without thin provisioning. In other words, memory address mapping as discussed herein may occur in “thin” provisioned or “thick” provisioned contexts. Furthermore, both thick and thin provisioning techniques may be used in the same implementation.

Additionally, or alternatively, each compute node may be pre-assigned some amount of memory capacity in the disaggregated memory pool. If and when a particular compute node completely fills its assignment and requests a larger assignment, the node may negotiate with the memory control system (e.g., CPMC) to determine whether and how much additional memory the node should be assigned, and this may include reducing the assignment reserved for another node. In this manner, the amount of memory capacity available in the disaggregated pool may be carefully balanced and divided between the plurality of compute nodes in keeping with each node's actual needs, rather than allow each individual compute node to seize pool capacity they have no need for.

FIG. 1 also schematically depicts a fabric manager 108. The fabric manager may be configured to monitor and govern the entire computing environment, including the plurality of compute nodes and disaggregated memory pool. The fabric manager may, for example, set and apply policies that facilitate efficient and secure use of the disaggregated memory pool by each of the plurality of compute nodes.

However, when memory is disaggregated in this manner, it will typically increase the total latency associated with access to data held in the disaggregated memory pool, as compared to accessing data from natively attached memory. This may occur, for example, due to presence of additional interlinks and processing componentry (e.g., CPMCs, CXL switches) between each compute node and the memory it is attempting to access. Depending on how memory disaggregation is implemented, this latency can be unsuitably high, resulting in a significant number of wasted clock cycles as data is retrieved from the disaggregated memory pool.

The present disclosure therefore describes techniques for memory caching in a disaggregated memory context. As shown in FIG. 1, each memory control system (e.g., CPMC) includes a memory cache (105A and 105B) configured to cache some amount of data stored in the corresponding physical memory units (106A and 106B). The memory cache may be implemented in such a way as to significantly reduce the latency of accessing data from the cache, as compared to accessing data from the physical memory units, as will be described in more detail below. The memory cache may be implemented using any suitable memory/caching technology—e.g., static random-access memory (SRAM). In this manner, the advantages of memory disaggregation can be achieved (e.g., more efficient use of resources via reduction in resource stranding) while at least partially mitigating any disadvantages—e.g., increased latency.

It will be understood that, in the example of FIG. 1, data from the disaggregated memory pool is cached in a memory-side cache controlled by the memory control system. However, this does not preclude existence of other data caches elsewhere within the extended computing environment. For example, individual compute nodes may include node-specific caches (e.g., CPU caches, or natively attached memory caches), and/or there may be other caches present in the extended computing environment, such as at a CXL switch. Notably, however, such caches may have limited compatibility with different CPU models, CXL switch models, or other variable hardware. By contrast, the memory cache described herein may be substantially agnostic to the CPU/switch types, models, and brands due to the positioning of the memory cache within the disaggregated memory pool.

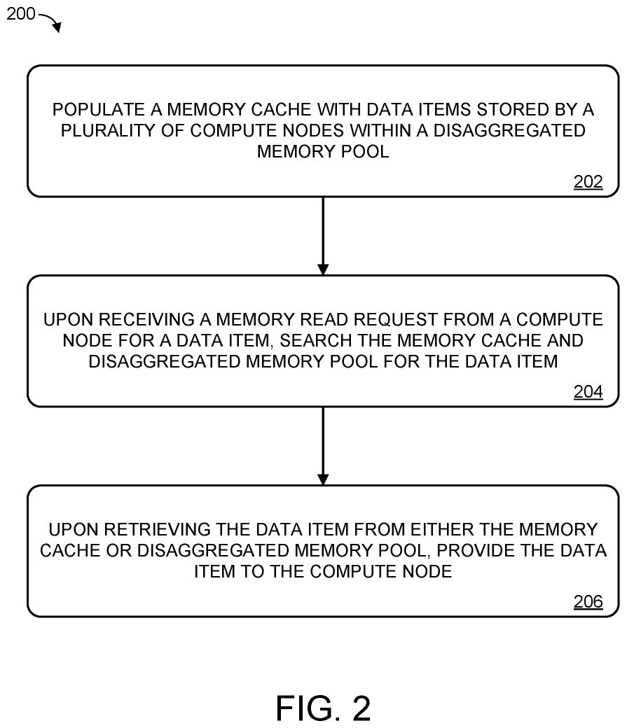

FIG. 2 illustrates an example method 200 for memory caching in a disaggregated memory pool. Method 200 may be implemented using any suitable collection of computer hardware, having any suitable capabilities and form factor. In one example, method 200 may be implemented via a memory control system (e.g., a CPMC), such as memory control systems 104A and 104B. Such a memory control system may include suitable processing componentry useable to implement steps of method 200, such as logic subsystem 702 described below. Any or all of the computing systems described herein, including the compute nodes, memory control systems, and fabric manager, may be implemented as computing system 700 described below with respect to FIG. 7.

At 202, method 200 includes populating a memory cache with data items according to a cache fill policy. Specifically, the memory cache is populated with data items stored within the disaggregated memory pool by the plurality of compute nodes. The data items may in some cases correspond to cache lines, which may in turn have any suitable size—e.g., 64 bits. However, for the purposes of this disclosure, a “data item” may refer to any suitable unit or increment of computer data, which may be stored and organized in any suitable way.

This is schematically illustrated in FIG. 3, which depicts an example set of physical memory units 300. As discussed above, the set of physical memory units may include any number of individual memory media—e.g., RAM DIMMs—having any suitable capacity and utilizing any suitable technology. The set of physical memory units may in turn store any number of data items 302A-D, which again may correspond to any suitable unit or increment of computer data.

As shown, the memory control system populates a memory cache 306 with some of the data items stored in the set of physical memory units. In this example, the memory cache is populated with data items 302B and 302D. In general, the memory cache may be populated with any suitable number of data items, though this number will typically be lower than the number of total data items stored by the plurality of physical memory units.

The specific data items used to populate the memory cache are chosen according to a cache fill policy 304. The memory control system may maintain any number of different cache fill policies configured to populate the memory cache with different data items based on different workloads, memory access behaviors, or other considerations. As examples, cache fill policies may utilize replacement algorithms, such as a least recently used (LRU) or random replacement algorithm.

Additionally, or alternatively, populating the memory cache according to the cache fill policy may include prefetching one or more data items predicted to be requested next by any of the plurality of compute nodes. For example, upon receiving and servicing a request for a particular data item from a compute node, the memory control system may automatically populate the memory cache with one or more additional data items corresponding, for example, to the next data items in an address range or allocation slice assigned to the compute node. Additionally, or alternatively, prefetching may be done on the basis of historical memory accesses. For example, the memory control system may determine that, statistically, a set of data items are often requested in a predictable order (e.g., due to execution of a software application on a compute node), and thus may prefetch the entire set of data items upon receiving a memory read request for any data items in the set. As another example, the memory control system may determine which data items are requested most often by one or more of the plurality of compute nodes, and prefetch such data items. Prefetching may in some cases be facilitated using suitable machine learning techniques.

Furthermore, the memory control system may in some cases populate the memory cache using different cache fill policies for different compute nodes of the plurality. This may be beneficial, given that different compute nodes may often be tasked with significantly different workloads, and therefore may exhibit significantly different memory access behaviors. For example, the memory control system may populate the cache according to an LRU replacement algorithm for one compute node, but use historical access-based prefetching for a different compute node.

Returning to FIG. 2, at 204, method 200 includes, upon receiving a memory read request for a data item from a compute node, searching the memory cache and disaggregated memory pool for the data item. Notably, in some examples, this searching may be done in parallel, rather than in series. To illustrate this, some approaches to data caching will, upon receiving a request for a data item, first search only the memory cache before searching the physical memory media (e.g., RAM). Such series-based searching may achieve significantly low latency, but only assuming that the data item is actually found in the cache. In the common scenario in which the data item is not found within the memory cache (i.e., a “cache miss), significant additional latency is incurred, as the memory controller must then search the set of physical memory units substantially from scratch.

Accordingly, as an alternative, the memory cache and set of physical memory units may in some cases be searched in parallel. In other words, when the memory control system receives a read request for a data item, the memory control system begins searching both the memory cache and plurality of physical memory units substantially at the same time. This has the benefit of introducing little to no additional latency on a cache miss, because even if the data item is not found in the memory cache, a search for the data item within the plurality of physical memory units is already ongoing.

Continuing with FIG. 2, at 206, method 200 includes, upon retrieving the data item from either the memory cache or disaggregated memory pool, providing the data item to the compute node. The overall latency associated with accessing the data item may depend on whether the data item was ultimately retrieved from the memory cache or plurality of physical memory units. While searching in parallel adds little to no additional latency on cache miss, as discussed above, accessing data from the memory cache will still have a lower overall latency than accessing the same data from the plurality of physical memory units. Thus, upon retrieving the data item from the memory cache, the data item may be provided to the compute node before the data item is identified within the plurality of physical memory units. Once the data item is identified within the plurality of physical memory units, it may simply be discarded rather than provided to the compute node, as the compute node has already retrieved the data item from the memory cache.

The specific latency values associated with retrieving data items from the memory cache vs the plurality of physical memory units may vary from implementation to implementation—e.g., due to the specific memory and caching technologies used. In one example, on cache hit, the data item may be retrieved from the memory cache with a latency of between 100 and 200 ns. By contrast, on cache miss, the data item may be retrieved from the plurality of physical memory units with a latency of between 140 and 240 ns.

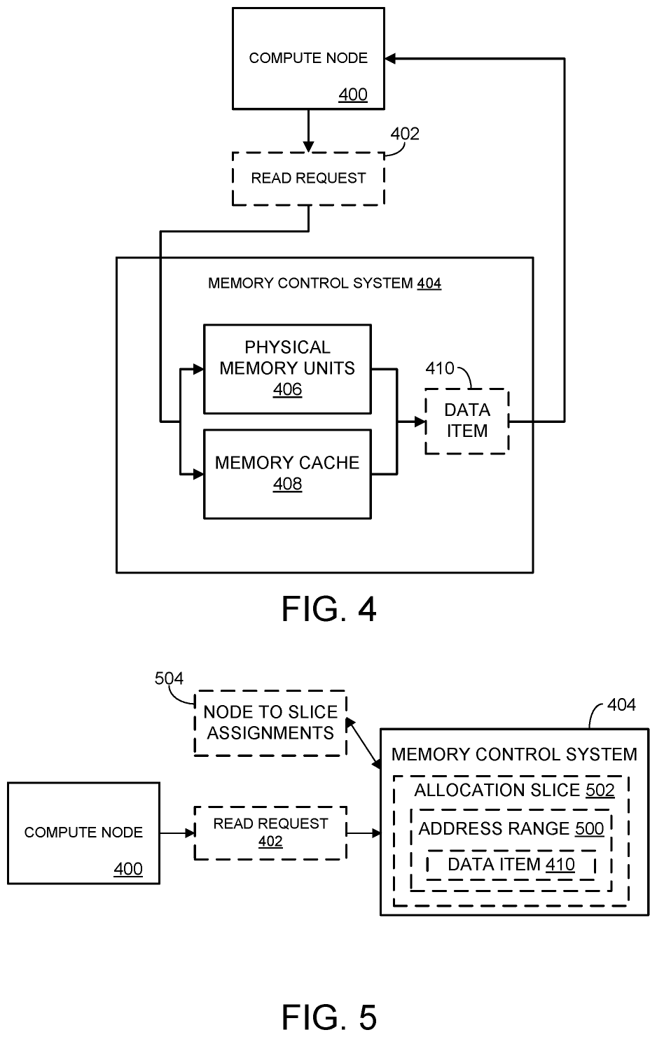

Parallel searching and retrieving of a data item by a memory control system is schematically illustrated with respect to FIG. 4. As shown, an example compute node 400 (which may be one compute node of a larger set as described above) sends a memory read request 402 to a memory control system 404 (e.g., CPMC). Upon receiving the read request, the memory controller searches both a plurality of physical memory units 406 and a memory cache 408 in parallel, ultimately identifying the requested data item 410 in either the plurality of physical memory units or memory cache. At this point, the data item may be provided to the compute node as requested.

In some cases, after receiving the memory receive request from the compute node, the memory control system may confirm that the compute node is authorized to access an address range including the data item. Specifically, memory addresses of the plurality of physical memory units may be organized by the memory control system as a plurality of pooled physical addresses (PPAs). Any particular data item requested by a compute node may be mapped to one such PPA, corresponding to a media-specific element of an individual physical memory unit—e.g., in the case of RAM, the data item may be mapped to a DIMM, bank, bank group, row, and column of a particular RAM unit.

Different ranges of these PPAs may be assigned to different compute nodes of the plurality. Such address ranges may in some cases be referred to as memory “allocation slices,” where the total capacity of the disaggregated memory pool is divided into some number of such allocation slices. Any given allocation slice may include one or more ranges of different PPAs, which in some cases may be interleaved between multiple different physical memory units of the plurality. Each allocation slice may have any suitable size—e.g., 0.5 GB, 1 GB, 2 GB, 4 GB. Confirming that the compute node is authorized to access the address range including the data item may therefore include determining that the address range is included in a memory allocation slice that has been allocated to the compute node.

This is schematically illustrated with respect to FIG. 5, which again shows compute node 400 sending read request 402 to memory control system 404. The requested data item 410 is held by the plurality of physical memory units controlled by the memory control system, falling within an address range 500 (e.g., a range of PPAs), and may additionally be stored in the memory cache (e.g., due to population of the memory cache as described above). The address range 500 in turn falls within a memory allocation slice 502, which may be one of many allocation slices that are assignable to the plurality of compute nodes. Before providing the data item to the compute node, the memory control system may first consult an index 504 defining node-to-slice assignments. This index may, for example, take the form of a lookup table or other data structure that includes, for each allocation slice, an identifier of a compute node that the slice has been assigned to. In this manner, the memory control system may ensure that compute nodes are not granted access to memory addresses (and corresponding data items) that have not been assigned to them.

As discussed above, access to the memory cache (as well as the rest of the disaggregated memory pool) may be shared between each of a plurality of compute nodes. Accordingly, in some examples, the total data capacity and/or access bandwidth available to each of the plurality of compute nodes with respect to the memory cache may be dynamically controllable. In other words, one or more of the plurality of compute nodes may be allocated different maximum capacities, and/or maximum access bandwidths, within the memory cache. This may be done to prevent any individual compute node from monopolizing the capacity and/or available bandwidth of the memory cache, except in cases where such monopolization may be desired.

With respect to setting maximum capacities, in some cases this may be done by assigning different cache ways of the memory cache to the one or more compute nodes—e.g., in an m-way set associative cache scheme. In other words, the cache may be divided into a plurality of sets each including m blocks, where m is any suitable positive integer. Thus, any particular memory address may map to one of the plurality of sets, and data for the particular memory address may be stored in any of the m blocks (or “ways”) of that set. In a simplified example in which access to the memory cache is shared between two compute nodes, one node may be assigned even cache ways of the memory cache, while the other node is assigned odd cache ways. It will be understood that this may be dramatically scaled up in cases where dozens, hundreds, or thousands of compute nodes share access to the same memory cache.

Furthermore, the amount of capacity and bandwidth available for each individual compute node may be determined in any suitable way. In some cases, these may be set by a fabric manager (e.g., fabric manager 108 of FIG. 1) configured to coordinate and govern use of the disaggregated memory pool (including the memory cache) by the plurality of compute nodes. For example, the different maximum capacities, and/or different maximum access bandwidths for the plurality of compute nodes may be specified by quality of service (QoS) policies sent to the memory control system by the fabric manager.

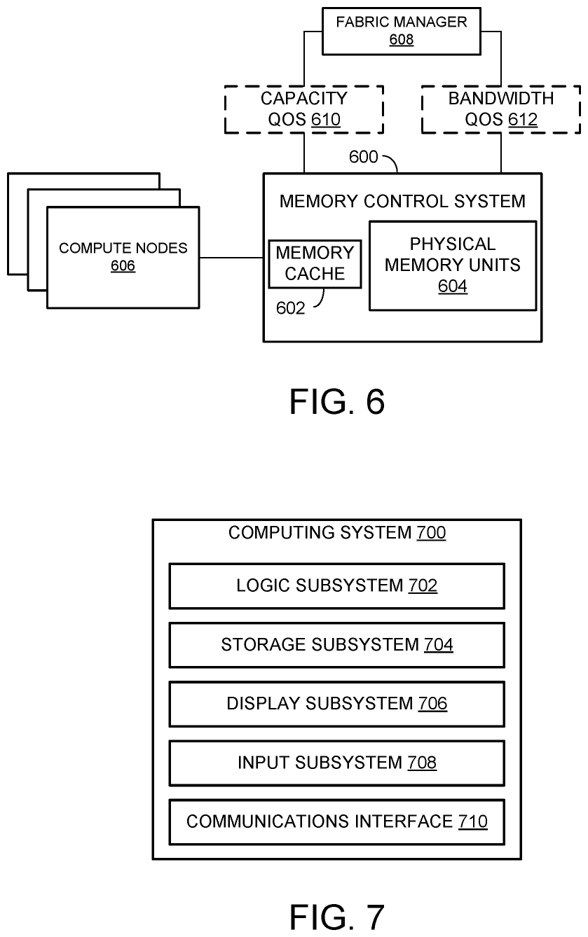

This is schematically illustrated with respect to FIG. 6, which shows another example memory control system 600 including a memory cache 602, a plurality of physical memory units 604, and communicatively coupled with a plurality of compute nodes 606. From a fabric manager 608, the memory control system receives a capacity QoS policy 610 and a bandwidth QoS policy 612 defining, for one or more of the plurality of compute nodes, maximum storage capacities and/or access bandwidths for accessing the memory cache.

Over time, as workloads distributed between the plurality of compute nodes change, the overall memory needs and behaviors of each compute node may change. Accordingly, in some examples, the fabric manager may send new QoS policies that replace or overwrite previous policies. For example, when a compute node's memory needs decrease, the fabric manager may provide a new QoS policy that reduces that compute node's total memory capacity within the memory cache. Such policy changes may additionally alter cache fill policies, node-to-slice assignments, and/or any other suitable properties of the extended computing environment.

The methods and processes described herein may be tied to a computing system of one or more computing devices. In particular, such methods and processes may be implemented as an executable computer-application program, a network-accessible computing service, an application-programming interface (API), a library, or a combination of the above and/or other compute resources.

FIG. 7 schematically shows a simplified representation of a computing system 700 configured to provide any to all of the compute functionality described herein. Computing system 700 may take the form of one or more personal computers, network-accessible server computers, tablet computers, home-entertainment computers, gaming devices, mobile computing devices, mobile communication devices (e.g., smart phone), virtual/augmented/mixed reality computing devices, wearable computing devices, Internet of Things (IoT) devices, embedded computing devices, and/or other computing devices.

Computing system 700 includes a logic subsystem 702 and a storage subsystem 704. Computing system 700 may optionally include a display subsystem 706, input subsystem 708, communication subsystem 710, and/or other subsystems not shown in FIG. 7.

Logic subsystem 702 includes one or more physical devices configured to execute instructions. For example, the logic subsystem may be configured to execute instructions that are part of one or more applications, services, or other logical constructs. The logic subsystem may include one or more hardware processors configured to execute software instructions. Additionally, or alternatively, the logic subsystem may include one or more hardware or firmware devices configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely-accessible, networked computing devices configured in a cloud-computing configuration.

Storage subsystem 704 includes one or more physical devices configured to temporarily and/or permanently hold computer information such as data and instructions executable by the logic subsystem. When the storage subsystem includes two or more devices, the devices may be collocated and/or remotely located. Storage subsystem 704 may include volatile, nonvolatile, dynamic, static, read/write, read-only, random-access, sequential-access, location-addressable, file-addressable, and/or content-addressable devices. Storage subsystem 704 may include removable and/or built-in devices. When the logic subsystem executes instructions, the state of storage subsystem 704 may be transformed—e.g., to hold different data.

Aspects of logic subsystem 702 and storage subsystem 704 may be integrated together into one or more hardware-logic components. Such hardware-logic components may include program- and application-specific integrated circuits (PASIC/ASICs), program- and application-specific standard products (PSSP/ASSPs), system-on-a-chip (SOC), and complex programmable logic devices (CPLDs), for example.

The logic subsystem and the storage subsystem may cooperate to instantiate one or more logic machines. As used herein, the term “machine” is used to collectively refer to the combination of hardware, firmware, software, instructions, and/or any other components cooperating to provide computer functionality. In other words, “machines” are never abstract ideas and always have a tangible form. A machine may be instantiated by a single computing device, or a machine may include two or more sub-components instantiated by two or more different computing devices. In some implementations a machine includes a local component (e.g., software application executed by a computer processor) cooperating with a remote component (e.g., cloud computing service provided by a network of server computers). The software and/or other instructions that give a particular machine its functionality may optionally be saved as one or more unexecuted modules on one or more suitable storage devices.

When included, display subsystem 706 may be used to present a visual representation of data held by storage subsystem 704. This visual representation may take the form of a graphical user interface (GUI). Display subsystem 706 may include one or more display devices utilizing virtually any type of technology. In some implementations, display subsystem may include one or more virtual-, augmented-, or mixed reality displays.

When included, input subsystem 708 may comprise or interface with one or more input devices. An input device may include a sensor device or a user input device. Examples of user input devices include a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition.

When included, communication subsystem 710 may be configured to communicatively couple computing system 700 with one or more other computing devices. Communication subsystem 710 may include wired and/or wireless communication devices compatible with one or more different communication protocols. The communication subsystem may be configured for communication via personal-, local- and/or wide-area networks.

This disclosure is presented by way of example and with reference to the associated drawing figures. Components, process steps, and other elements that may be substantially the same in one or more of the figures are identified coordinately and are described with minimal repetition. It will be noted, however, that elements identified coordinately may also differ to some degree. It will be further noted that some figures may be schematic and not drawn to scale. The various drawing scales, aspect ratios, and numbers of components shown in the figures may be purposely distorted to make certain features or relationships easier to see.

In an example, a memory control system comprises: a memory cache; and processing componentry configured to: populate the memory cache with data items stored by a plurality of compute nodes within a disaggregated memory pool according to a cache fill policy, the disaggregated memory pool including a plurality of physical memory media configured to provide volatile data storage for any of the plurality of compute nodes communicatively coupled with the disaggregated memory pool; upon receiving, from a compute node of the plurality, a memory read request for a data item stored in the disaggregated memory pool, search the memory cache and disaggregated memory pool for the data item; and upon retrieving the data item from either the memory cache or disaggregated memory pool, provide the data item to the compute node. In this example or any other example, the memory cache and disaggregated memory pool are searched in parallel. In this example or any other example, the processing componentry is further configured to, upon retrieving the data item from the memory cache, provide the data item to the compute node before the data item is retrieved from the disaggregated memory pool. In this example or any other example, the processing componentry is further configured to, after receiving the memory read request from the compute node, confirm that the compute node is authorized to access an address range including the data item. In this example or any other example, confirming that the compute node is authorized to access the address range including the data item comprises determining that the address range is included in a memory allocation slice that has been allocated to the compute node. In this example or any other example, populating the memory cache according to the cache fill policy includes prefetching one or more data items predicted to be requested next by any of the plurality of compute nodes. In this example or any other example, one or more of the plurality of compute nodes are allocated different maximum capacities within the memory cache. In this example or any other example, the different maximum capacities are set based on quality of service (QoS) policies received from a fabric manager. In this example or any other example, the different maximum capacities are set based on assigning different cache ways of the memory cache to the one or more compute nodes. In this example or any other example, the processing componentry is configured to receive a quality of service (QoS) policy from a fabric manager specifying different maximum access bandwidths for one or more compute nodes of the plurality, for accessing the memory cache. In this example or any other example, the processing componentry is configured to populate the memory cache using different cache fill policies for different compute nodes of the plurality. In this example or any other example, the memory control system is a compute express link (CXL)-compliant memory controller.

In an example, a method for memory caching comprises: populating a memory cache with data items stored by a plurality of compute nodes within a disaggregated memory pool according to a cache fill policy, the disaggregated memory pool including a plurality of physical memory media configured to provide volatile data storage for any of the plurality of compute nodes; upon receiving, from a compute node of the plurality, a memory read request for a data item stored in the disaggregated memory pool, searching the memory cache and disaggregated memory pool for the data item; and upon retrieving the data item from either the memory cache or disaggregated memory pool, providing the data item to the compute node. In this example or any other example, the memory cache and disaggregated memory pool are searched in parallel. In this example or any other example, one or more of the plurality of compute nodes are allocated different maximum capacities within the memory cache. In this example or any other example, the method further comprises receiving a quality of service (QoS) policy from a fabric manager specifying different maximum access bandwidths for one or more compute nodes of the plurality, for accessing the memory cache. In this example or any other example, the memory cache is populated using different cache fill policies for different compute nodes of the plurality. In this example or any other example, the method further comprises, upon retrieving the data item from the memory cache, providing the data item to the compute node before the data item is retrieved from the disaggregated memory pool. In this example or any other example, populating the memory cache according to the cache fill policy includes prefetching one or more data items predicted to be requested next by any of the plurality of compute nodes.

In an example, a memory control system comprises: a memory cache; a disaggregated memory pool including a plurality of physical memory media configured to provide volatile data storage for any of a plurality of compute nodes communicatively coupled with the disaggregated memory pool; and processing componentry configured to: populate the memory cache with data items stored by the plurality of compute nodes within the disaggregated memory pool using a plurality of different cache fill policies corresponding to the plurality of compute nodes; apply a quality of service (QoS) policy specifying different maximum capacities and maximum access bandwidths for the plurality of compute nodes, for accessing the memory cache; upon receiving, from a compute node of the plurality, a memory read request for a data item stored in the disaggregated memory pool, search the memory cache and disaggregated memory pool in parallel for the data item; and upon retrieving the data item from the memory cache, provide the data item to the compute node before the data item is retrieved from the disaggregated memory pool.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A memory control system, comprising:
a memory cache; and
processing componentry configured to:
populate the memory cache with data items stored by a plurality of compute nodes within a disaggregated memory pool according to a cache fill policy, the disaggregated memory pool including a plurality of physical memory media configured to provide volatile data storage for any of the plurality of compute nodes communicatively coupled with the disaggregated memory pool;
upon receiving, from a compute node of the plurality, a memory read request for a data item stored in the disaggregated memory pool, search the memory cache and disaggregated memory pool for the data item; and
upon retrieving the data item from either the memory cache or disaggregated memory pool, provide the data item to the compute node.

2. The memory control system of claim 1, where the memory cache and disaggregated memory pool are searched in parallel.

3. The memory control system of claim 2, where the processing componentry is further configured to, upon retrieving the data item from the memory cache, provide the data item to the compute node before the data item is retrieved from the disaggregated memory pool.

4. The memory control system of claim 1, where the processing componentry is further configured to, after receiving the memory read request from the compute node, confirm that the compute node is authorized to access an address range including the data item.

5. The memory control system of claim 4, where confirming that the compute node is authorized to access the address range including the data item comprises determining that the address range is included in a memory allocation slice that has been allocated to the compute node.

6. The memory control system of claim 1, where populating the memory cache according to the cache fill policy includes prefetching one or more data items predicted to be requested next by any of the plurality of compute nodes.

7. The memory control system of claim 1, where one or more of the plurality of compute nodes are allocated different maximum capacities within the memory cache.

8. The memory control system of claim 7, where the different maximum capacities are set based on quality of service (QoS) policies received from a fabric manager.

9. The memory control system of claim 7, where the different maximum capacities are set based on assigning different cache ways of the memory cache to the one or more compute nodes.

10. The memory control system of claim 1, where the processing componentry is configured to receive a quality of service (QoS) policy from a fabric manager specifying different maximum access bandwidths for one or more compute nodes of the plurality, for accessing the memory cache.

11. The memory control system of claim 1, where the processing componentry is configured to populate the memory cache using different cache fill policies for different compute nodes of the plurality.

12. The memory control system of claim 1, where the memory control system is a compute express link (CXL)-compliant memory controller.

13. A method for memory caching, comprising:
populating a memory cache with data items stored by a plurality of compute nodes within a disaggregated memory pool according to a cache fill policy, the disaggregated memory pool including a plurality of physical memory media configured to provide volatile data storage for any of the plurality of compute nodes;
upon receiving, from a compute node of the plurality, a memory read request for a data item stored in the disaggregated memory pool, searching the memory cache and disaggregated memory pool for the data item; and
upon retrieving the data item from either the memory cache or disaggregated memory pool, providing the data item to the compute node.

14. The method of claim 13, where the memory cache and disaggregated memory pool are searched in parallel.

15. The method of claim 13, where one or more of the plurality of compute nodes are allocated different maximum capacities within the memory cache.

16. The method of claim 13, further comprising receiving a quality of service (QoS) policy from a fabric manager specifying different maximum access bandwidths for one or more compute nodes of the plurality, for accessing the memory cache.

17. The method of claim 13, where the memory cache is populated using different cache fill policies for different compute nodes of the plurality.

18. The method of claim 13, further comprising, upon retrieving the data item from the memory cache, providing the data item to the compute node before the data item is retrieved from the disaggregated memory pool.

19. The method of claim 13, where populating the memory cache according to the cache fill policy includes prefetching one or more data items predicted to be requested next by any of the plurality of compute nodes.

20. A memory control system, comprising:
a memory cache;
a disaggregated memory pool including a plurality of physical memory media configured to provide volatile data storage for any of a plurality of compute nodes communicatively coupled with the disaggregated memory pool; and
processing componentry configured to:
populate the memory cache with data items stored by the plurality of compute nodes within the disaggregated memory pool using a plurality of different cache fill policies corresponding to the plurality of compute nodes;
apply a quality of service (QoS) policy specifying different maximum capacities and maximum access bandwidths for the plurality of compute nodes, for accessing the memory cache;
upon receiving, from a compute node of the plurality, a memory read request for a data item stored in the disaggregated memory pool, search the memory cache and disaggregated memory pool in parallel for the data item; and
upon retrieving the data item from the memory cache, provide the data item to the compute node before the data item is retrieved from the disaggregated memory pool.
